(19) United States
(12) Patent Application Publication
(10) Pub. No.: US 2006/0034283 A1
(43) Pub. Date: Feb. 16, 2006

(54) Method and system for providing direct data placement support

(76) Inventors: Michael Anthony Ko, San Jose, CA (US); Renato J. Recio, Austin, TX (US); Prasenjit Sarkar, San Jose, CA (US)

Correspondence Address: LACASSE & ASSOCIATES, LLC, 1725 DUKE STREET, SUITE 650, ALEXANDRIA, VA, 22314, US

(21) Appl. No.: 10/917,508

(22) Filed: Aug. 13, 2004

(51) Int. Cl. H04L 12/56

(52) U.S. Cl. 370/392; 370/466

(57) ABSTRACT

A system and method for reducing the overhead associated with direct data placement is provided. Processing time overhead is reduced by implementing packet-processing logic in hardware. Storage space overhead is reduced by combining results of hardware-based packet-processing logic with ULP software support; parameters relevant to direct data placement are extracted during packet-processing and provided to a control structure instantiation. Subsequently, payload data received at a network adapter is directly placed in memory in accordance with parameters previously stored in a control structure. Additionally, packet-processing in hardware reduces interrupt overhead by issuing system interrupts in conjunction with packet boundaries. In this manner, wire-speed direct data placement is approached, zero copy is achieved, and per byte overhead is reduced with respect to the amount of data transferred over an individual network connection. Movement of ULP data between application-layer program memories is thereby accelerated without a fully offloaded TCP protocol stack implementation.

### BACKGROUND OF THE INVENTION

1. Field of Invention

The present invention relates generally to the field of direct data placement. More specifically, the present invention is related to reliable, direct data placement supported by transport layer functionality implemented in both software and hardware.

2. Discussion of Prior Art

As data transmission speeds over Ethernet increase from a single gigabit per second (Gbps) to tens of Gbps and beyond, a host central processing unit (CPU) becomes less and less capable of processing packets that are received and transmitted at these high data rates. One approach to meeting demands associated with increased data transmission speeds is to offload onto hardware, computation-intensive upper layer packet processing functionality that is traditionally implemented in software. Usually transferred to hardware in the form of a network adapter, also known as a network interface card (NIC), such an offload reduces packet processing load at a host CPU. In particular, offloading the Transmission Control Protocol/Internet Protocol (TCP/IP) protocol stack from a host CPU to a network adapter is known as a TCP Offload Engine (TOE) approach. Advantageously, a TOE approach reduces the number of CPU cycles used in processing TCP packet headers.

However, a TOE approach is limited in its need for a large, dedicated reassembly buffer to handle out-of-order TCP packets, thereby increasing the effective cost of a TOE implementation. A reassembly buffer is sized in proportion with the bandwidth delay product and in the case of ten Gbps network, such a reassembly buffer would need to be relatively large. The TOE approach is further limited by the cost and complexity associated with implementing a TCP/IP protocol stack in a network adapter, potentially increasing its time-to-market. By contrast, the performance of a general purpose CPU improves with time, which enables the CPU to more effectively handle higher data rates.

Furthermore, because the TCP/IP protocol is not static and is constantly being improved as new RFCs are adopted into standard (e.g., SACK and DSACK), it becomes necessary to periodically update the TCP/IP protocol stack in a TOE to incorporate the latest modifications to the standard. A TCP/IP stack as implemented in a programmable TOE is potentially more difficult to update than a stack implementation in a host operating system (OS) and has the potential to be even more difficult to update if the TOE is non-programmable. The complexity of update is further compounded when a split protocol stack approach, in which the functionality of the TCP/IP stack is split between the OS and the TOE, is utilized.

In processing TCP packet headers, the header prediction approach first described by Van Jacobson demonstrated that, for the common case, it is possible to process TCP packet headers for a TCP connection using a relatively few number of instructions. In other words, even without a TOE, CPU cycle overhead incurred during header processing is relatively low for the common case, and therefore the benefit of CPU cycle reduction provided by a TOE is not substantial.

In a traditional TCP/IP stack, a significant amount of data copy overhead is incurred when received packets containing payload data that are initially saved in TCP buffers are subsequently copied to application buffers. To reduce data copy overhead on the receive path, support is obtained from upper layer protocols (ULPs) such as Internet Small Computer System Interface (iSCSI) and iWARP protocol suite, the latter of which consists of Remote Direct Memory Access Protocol (RDMAP), Direct Data Placement Protocol (DDP), and Marker PDU Aligned Framing for TCP (MPA). While iSCSI provides a protocol-unique solution by including data placement information in its headers to enable zero-copy, the iWARP protocol suite provides generic, Remote Direct Memory Access (RDMA) support to any ULP above a TCP/IP protocol stack to achieve zero-copy.

In order to provide direct data placement support for iSCSI and iWARP protocol suite solutions, it is necessary to offload the TCP/IP protocol stack onto a network adapter. In other words, a TOE is a prerequisite requirement for current approaches to direct data placement support. Thus, in requiring an offload of the TCP/IP protocol stack to a network adapter current approaches for reducing CPU processing overhead and supporting direct data placement are limited.

### SUMMARY OF THE INVENTION

Disclosed is a system and method supporting direct data placement in a network adapter and providing for the reduction of CPU processing overhead associated with direct data transfer. In an initial phase, parameters relevant to direct data placement are extracted by hardware logic implemented in a network adapter during processing of packet headers and are stored in a control structure instantiation. Payload data subsequently received at a network adapter is directly placed in an application buffer in accordance with previously written control parameters. In this manner, zero copy is achieved; TCP buffer storage space requirements are reduced since data is directly placed in the application buffer and data copy overhead is reduced by removing the CPU from the path of data movement. Furthermore, CPU processing overhead associated with interrupt processing is reduced by limiting system interrupts to packet boundaries.

Hardware support accelerating packet-processing on a network adapter transmit path is comprised of logic implementing: transport layer packet payload segmentation; ULP packet segmentation; checksum generation for IP, UDP, and TCP protocol packets; as well as cyclic redundancy checks (CRC), header and data digests, and marker insertion for ULP packets. For a packet on a network adapter receive path, interrupts are reduced in number by interrupting on message boundaries and packet-processing is accelerated by hardware-implemented logic comprising: checksum verification for protocol packets and CRC verification and marker removal for ULP packets.

A Connection Control Block (CCB) maintains information associated with a network connection and a corresponding Input/Output Control Block (ICB) is initialized with extracted direct data placement information for those packets for which direct data placement of payload is desired. Payload data is placed as it is received by a network adapter, in accordance with a consultation of an ICB.

### BRIEF DESCRIPTION OF THE DRAWINGS

FIG. 1 a illustrates an initial phase of accelerated packet-processing flow supported by hardware logic.

FIG. 1b illustrates a Connection Control Block (CCB) data structure and a CCB hash table.

FIG. 1c illustrates a final phase of accelerated packet-processing flow supported by hardware logic.

FIG. 2a illustrates an Input/Output Control Block (ICB) data structure and an ICB hash table.

FIG. 2b illustrates direct data placement process flow of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

I. Hardware Support of Accelerating Packet Reception and Transmission

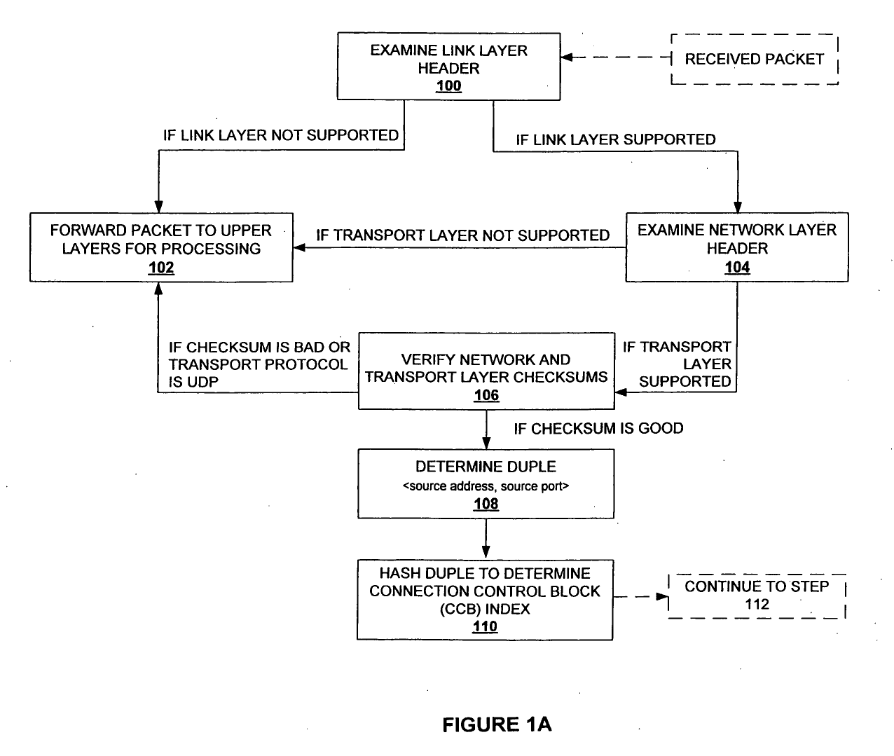

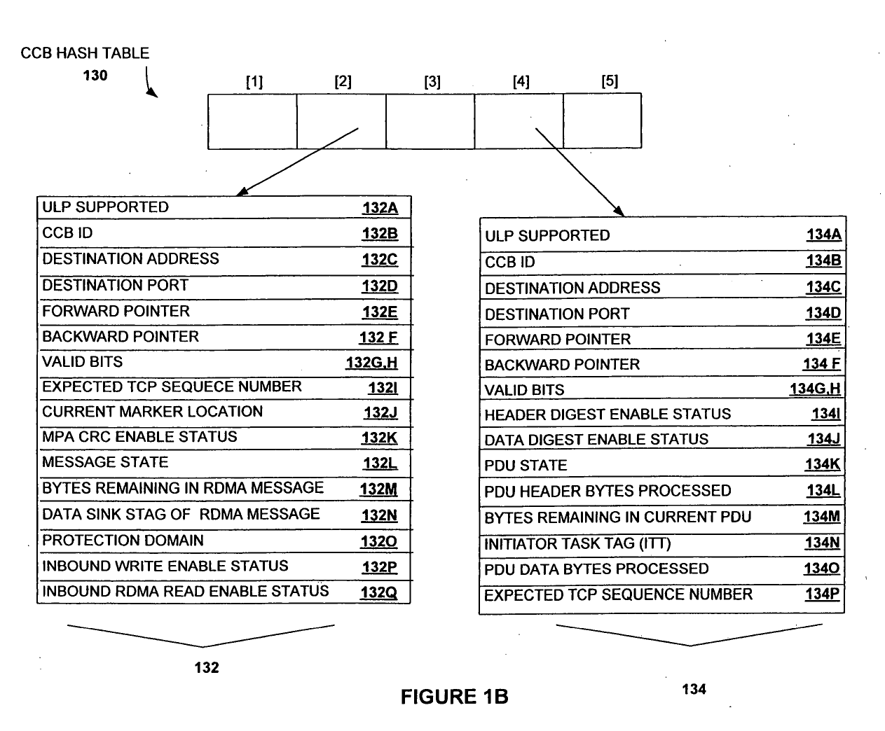

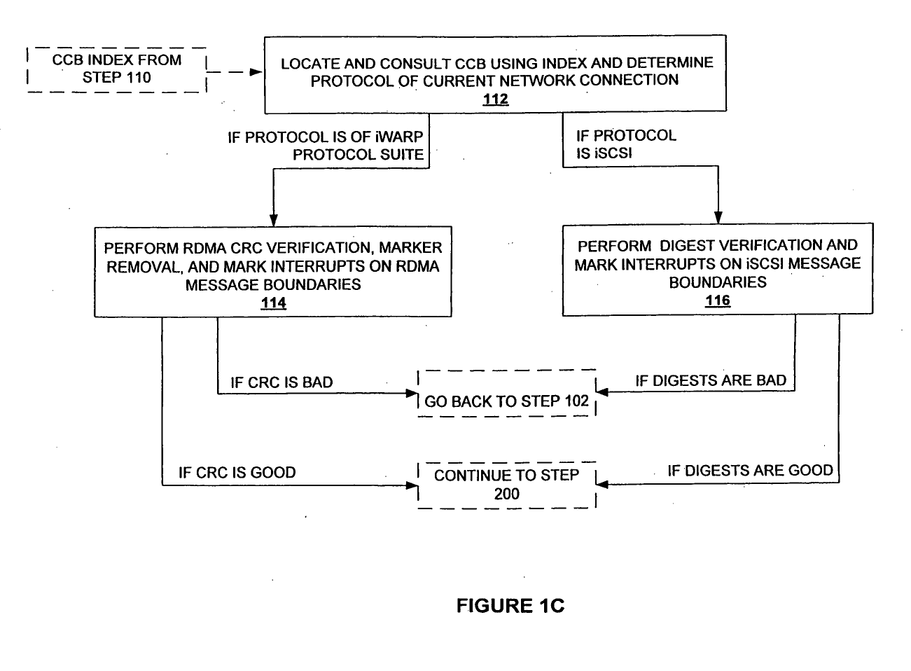

Referring now to FIG. 1a, a process flow diagram for the first phase of processing a packet received over a network connection, is shown. Upon receipt of a packet, it is determined whether the received packet meets eligibility requirements for hardware acceleration support by examining the packet's link layer protocol header, in step 100. Packet processing proceeds to step 102 if the examined link layer header does not meet eligibility requirements, necessary to obtain acceleration support and the received packet is forwarded to higher layer protocols implemented in software for routine processing. Otherwise, packet processing continues to step 104, during which a protocol field of an IP header associated with the received packet is examined. Packet processing proceeds to step 106, if the examined protocol field indicates support of a transport layer, during which a network layer (IP) checksum is verified along with a transport layer checksum (e.g., TCP or UDP). In step 108, destination address and destination port information in the received packet header is examined to determine whether examined information matches values known to the network adapter over which they are received. Otherwise, if any one of the following occurs, respectively with each consecutive step: the examined protocol field does not indicate any supported transport layer, verified checksums are bad, does not match the values known to a network adapter over which they are received (i.e., destination information previously seen and stored), packet processing proceeds to step 102 and the received packet is forwarded to higher layer protocols implemented in software for routine processing. Similarly, packet processing is completed and proceeds to step 102 if transport layer protocol is UDP.

If a received packet has made it through each check and examination, a duple associated is determined by extracting source address and source port information from IP and TCP headers, in step 108. Source address and source port information of a transmitting node (hereafter, remote node) as specified by headers of a received packet, are stored as a destination address and destination port at a recipient node (hereafter, local node). The duple determined in step 108 is hashed to determine an index to a Connection Control Block (CCB) hash table, which provides a pointer referencing a CCB control structure instantiation storing control parameters associated with a given network connection between a remote and local node, in step 110.

Shown in FIG. 1b are control parameters stored in and referenced by an exemplary CCB. Once a CCB corresponding to a received packet has been located or instantiated, packet processing continues to step 112, as shown in FIG. 1c, during which ULP supported 132a control parameter in CCB 132 is consulted to determine whether the current network connection conforms to definitions set forth by either iSCSI or iWARP protocol suite. If the current network connection is determined to conform to iWARP protocol suite, packet processing proceeds to step 114, during which MPA CRC enable status 132k control parameter stored by CCB 132 is checked for the enablement status of MPA CRC and control parameter current marker location 132j is consulted to obtain a previous marker location. If CRC is enabled, CRC verification for an RDMA message occurs, markers are removed based on a previous marker location, and interrupts are scheduled on RDMA message boundaries. If CRC is enabled and verification fails, the received packet is forwarded to software for processing in step 102. Packet processing reaches successful completion after data extracted from packet headers is used to update control parameters comprising: expected TCP sequence number 132i, current marker location 132j, message state 132l, and bytes remaining in RDMA message 132m stored in CCB 132.

If the current network connection is determined to conform to the iSCSI protocol, packet processing proceeds with step 116, during which control parameters header digest enable status 134i and data digest enable status 134j are checked for enablement. Pending results of an enablement check, iSCSI header and data digests are verified, and interrupts are scheduled on iSCSI PDU boundaries. If digests are enabled and verification fails, the received packet is forwarded to software for processing in step 102. Packet processing reaches successful completion after data extracted from packet headers is used to update control parameters comprising: PDU state 134k, PDU header bytes processed 134l, bytes remaining in current PDU 134m, PDU data bytes processed 134o, and expected TCP sequence number 134p stored in CCB 134.

For packets transmitted over a network connection, a descriptor associated with each transmit task specifies enabled offload functions. If a segmentation function is enabled, TCP packets, iSCSI PDUs, and RDMA messages are segmented to meet the Maximum Transmission Unit (MTU) requirement of an outgoing TCP link. Checksums are generated for IP, UDP, and TCP packets, if a checksum generation function is enabled. Similarly, packets for which either header or data digests are enabled; corresponding digests are computed and added to an iSCSI PDU. If an RDMA support function is enabled, a CRC is generated and appended to an RDMA message and markers are inserted in an RDMA message.

II. Software Data Structures Supporting Direct Data Placement

Referring back to FIG. 1b, CCB hash table 130 is shown. CCB hash table 130 is used to reference CCB instantiations containing control parameters associated with active network connections. A CCB is instantiated and initialized with control parameters describing a network connection associated with a received data packet. Control parameters associated with a network connection are protocol-specific for different ULPs (i.e., iSCSI and the iWARP protocol suite) and are updated as necessary by logic implemented in hardware as packets are received. Values of some control parameters are extracted from an incoming data packet by hardware logic, while others are specified by a software component. Each CCB 132, 134 identified by CCB ID 132b, 134b, is comprised of destination address 132c, 134c and port number 132d, 134d associated with a represented network connection.

As described earlier, the duple determined in step 108 is hashed to generate an index into a CCB hash table 130. If destination address 132c, 134c and port number 132d, 134d fields of CCB 132, 134 referenced by CCB hash table 130 matches source address and port information extracted from a received packet header, the desired CCB has been located. Otherwise, a collision avoidance mechanism is implemented to handle packets from different network connections hashing to the same CCB hash table 130 index. In one embodiment, a chaining method is used to prevent packets from different network connections from referencing a common CCB instantiation.

CCBs 132, 134 are further comprised of: backward pointers 132f, 134f used to locate another CCB for which either an associated destination address 132c, 134c or an associated port number 132d, 134d is smaller than the value of either a source address or source port in an incoming packet; and forward pointers 132e, 134e used to locate a CCB otherwise. Boolean, valid bits 132g,h 134g,h are associated with each pointer indicating the validity of an associated pointer. Upon network connection teardown, the corresponding CCB is invalidated. The use of a pointer scheme facilitates removal of a CCB representing a network connection that is to be torn down. Forward and backward pointers of CCBs ordered ahead of and behind a CCB to be removed are adjusted accordingly to remove an invalid CCB from the logical chain. Additionally, when a network connection is torn down and a CCB is removed, the corresponding CCB hash table index entry is updated to reference that which is referenced by either backward or forward pointers of the CCB to be removed.

CCB 132 is further comprised of control parameters associated with an iWARP connection including expected TCP sequence number 132i for the next TCP segment, current marker location 132j in terms of the TCP sequence number, Marker PDU Aligned framing protocol (MPA) CRC enable status 132k, number of bytes remaining in the RDMA message 132m, data sink STag 132n of the current RDMAP message, protection domain 132o, inbound RDMA write message enable status 132p, and inbound RDMA read response message enable status 132q. Message state 132l (e.g., between RDMA messages, processing RDMA message header, processing payload of an RDMA protocol (RDMAP) message, and processing payload of other RDMAP messages) is also stored in CCB 132. For an iSCSI connection, CCB 134 is further comprised of control parameters indicating enable status for header digest 134i, enable status for data digest 134j; PDU state 134k (e.g., between PDUs, processing a PDU header, processing a data segment of a data PDU, and processing a data segment of a non-data PDU), number of PDU header bytes processed 134l, number of bytes remaining in a current PDU 134m, and Initiator Task Tag (ITT) 134n of an active iSCSI data command. State information in a CCB allows communication between software and hardware components of the present invention regarding the nature of payload following a header in a received packet.

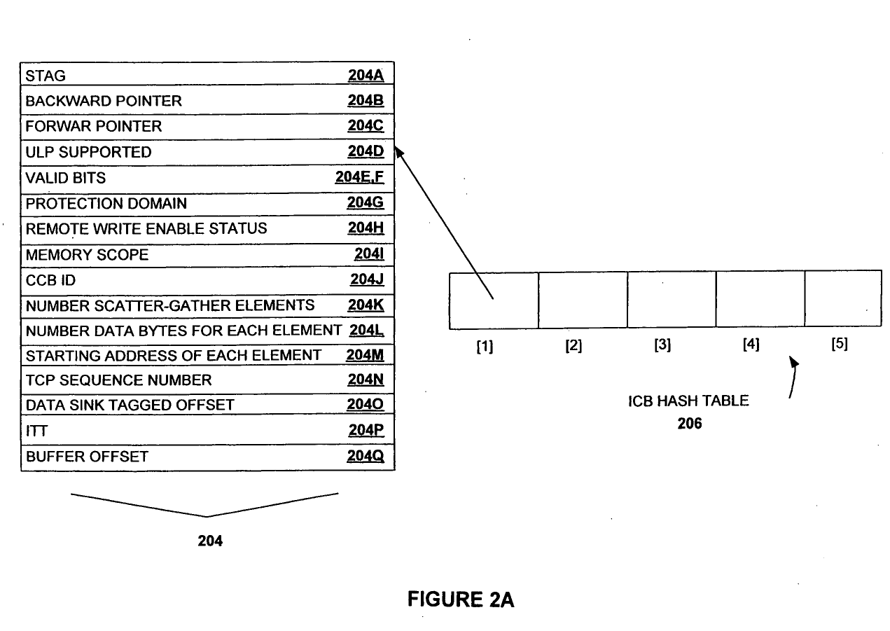

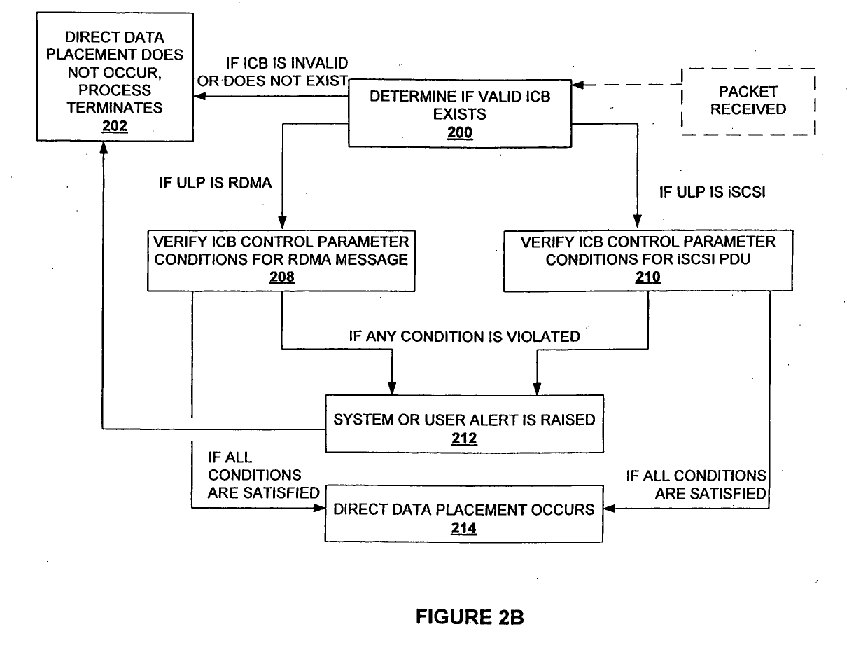

Shown in FIG. 2a is ICB 204 which is comprised of control parameters relevant to direct data placement. The software component instantiates and initializes an ICB 204 data structure for each incoming RDMA write message, RDMA read response message, or iSCSI data PDU where direct data placement of payload data is to be performed by the network adapter.

For an iWARP connection, the software component of the present invention is responsible for initializing an ICB for a new Steering Tag (STag) where direct data placement is desired as well as invalidating an ICB when direct data placement is no longer necessary (e.g., when an STag is invalid). If an ICB is not instantiated for an RDMA message, direct data placement does not occur. An STag extracted from an iWARP header and protection domain from a CCB representing an open iWARP network connection are hashed to generate an index for an ICB hash table 206, which provides a pointer reference to an ICB 204 containing direct data placement information for a particular RDMA message.

If the control parameter in ICB 204 referenced by ICB hash table 206, ULP supported 204d, indicates iWARP protocol suite, and STag 204a matches STag value extracted from iWARP header of an incoming RDMA message, and protection domain 204g in ICB 204 matches protection domain stored in a corresponding CCB representing a current iWARP connection, then a desired ICB has been located. Otherwise, a collision avoidance scheme is necessary to handle a collision in ICB hash table 206. In one embodiment, a chaining method is used. Backward pointer 204b is used to locate an ICB for which ULP supported 204d is not iWARP protocol suite. Backward pointer 204b is also used when STag 204a is smaller in value than STag of an incoming RDMA message, or protection domain 204g is smaller than the protection domain in a CCB for the corresponding iWARP connection. Otherwise, forward pointer 204c is used to locate an ICB. Boolean, valid bit 204e,f associated with each pointer indicates validity of a referenced ICB. A pointer scheme used for an ICB is the same as that used for a CCB, and thus insertion and deletion processes are facilitated in the same manner.

ICB 204 further comprises the following control parameters: remote write enable status 204h, memory scope (e.g., memory region, window) 204i, corresponding CCB ID 204j, number of elements in the scatter-gather list 204k, number of data bytes associated with each element of the scatter-gather list 204l, starting address of each element of the scatter-gather list 204m, TCP sequence number for first data byte 204n, data sink Tagged Offset 204o, Initiator Task Tag (ITT) 204p, and buffer offset 204q. Of the control parameters stored in an ICB, TCP sequence number for first data byte 204n, data sink Tagged Offset 204o, and buffer offset 204q are maintained by hardware. STag 204a, protection domain 204g, remote write enable status 204h, memory scope 204i, and data sink tagged offset 204o are updated and referenced when ULP supported 204g is the iWARP protocol suite. Similarly, ITT 204p and buffer offset 204q are utilized when ULP supported 204d is iSCSI.

For an iSCSI connection, an ICB is initialized with a new Initiator Task Tag (ITT) each time direct data placement is desired, and is invalidated when direct data placement has completed. ITT control parameter is extracted from iSCSI packet header and, along with CCB ID from a CCB associated with a current iSCSI network connection, is hashed to generate an index into ICB hash table 206. Such an index references a specific ICB 204 containing control parameters indicating direct data placement information for an iSCSI data PDU.

If control parameter ULP supported 204d, indicates iSCSI in a referenced ICB and ITT 204p matches ITT in iSCSI header of an incoming iSCSI data PDU, and CCB ID 204j in ICB 204 matches CCB ID in a CCB corresponding to the current iSCSI connection, a desired ICB has been located. Methods similar to that used for the iWARP connection can be used for the iSCSI connection to handle the collision avoidance ICB hash table 206, such as chaining. Forward pointer 204c is used to locate an ICB for which the ULP supported 204d is not iSCSI. Backward pointer 204b is utilized to locate an ITT 204p which is smaller in value than ITT of an incoming iSCSI data PDU, or if CCB ID 204j is smaller than CCB ID in a CCB corresponding to a current iSCSI network connection. Otherwise, forward pointer 204c is used to locate an ICB. Boolean, valid bit 204e,f associated with each pointer indicates the validity of a referenced ICB.

Direct Data Placement Process Flow

Referring now to FIG. 2b, a data flow diagram for direct data placement is shown. An incoming data packet for which accelerated packet processing in hardware has been successfully completed, is provided as input in step 200, where it is determined whether a valid ICB exists for an incoming data packet. If an ICB does not exist or is invalid, direct data placement does not occur and process terminates with step 202.

If the ULP is the iWARP protocol suite, then in step 208, the present invention verifies the following ICB control parameter conditions; remote write status 204h is enabled, protection domain in ICB 204g matches protection domain 132o in CCB if memory scope 204i indicates memory region, CCB ID 204j in ICB 204 matches CCB ID 132b in CCB 132 if memory scope 204i indicates memory window, and data offset and size of the payload data in an incoming RDMA message are within bounds of the buffer specified by scatter-gather list in ICB 204. Furthermore, in step 208, the present invention verifies that the RDMA message is in sequence; otherwise markers must be present that indicate that the RDMA message is properly aligned in a TCP segment and the MPA, DDP, and RDMAP headers and associated data are present in their entirety. The present invention verifies that inbound RDMA write is enabled 132p for an incoming RDMA write message, and inbound RDMA read is enabled 132q for an incoming RDMA read response message. If any of the conditions checked in step 208 are not met, an alert is raised in step 212 prompting a system or user to take appropriate, corrective action, direct data placement does not occur, and the process terminates in step 202. If all conditions are satisfactory, direct data placement occurs for payload data of the incoming RDMA message in step 214 using scatter-gather list 204k, 204l, 204m in obtained from ICB 204.

If ULP is iSCSI, then in step 210, the present invention verifies that the data offset and the size of the payload data in an incoming iSCSI PDU are within the bounds of the buffer specified by the scatter-gather list 204k, 204l, 204m contained in ICB 204. Also in step 210, the present invention verifies that the iSCSI PDU is received in order. If header digest is enabled 134i, then the present invention verifies that the header digest contained in the incoming iSCSI PDU is correct. If data digest is enabled 134j, then the present invention verifies that the data digest contained in the incoming iSCSI PDU is correct. If any of the conditions checked in step 210 are violated, an alert is raised in step 214 prompting a system or user to take appropriate, corrective action, direct data placement does not occur, and the process terminates in step 202. If all checked conditions are met, direct data placement occurs for payload data of an incoming iSCSI PDU in step 214 using scatter-gather list 204k, 204l, 204m in ICB 204.

Computational cost and complexity of implementation with regard to a network adapter is lessened since the components for TCP hardware acceleration are logically simpler than those required of a fully offloaded TCP stack. Having a host CPU processor handle TCP/IP processing allows scalability of performance with advances in CPU design. A provision for the integration of future enhancements to a TCP/IP protocol stack in also made, and with relatively little complexity due to a TCP/IP stack software implementation on a host's operating system.

Additionally, the present invention provides for an article of manufacture comprising computer readable program code contained within the implementation of one or more modules to store control parameters related to direct data transfer and placement data supported by partially offloaded TCP/IP functionality. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) maintaining network connection information in a first data structure; (b) developing a second data structure corresponding to network connections for which direct data transfer is desired; and (c) utilizing both first and second data structures to place directly, packet payload data.

### CONCLUSION

A system and method has been shown in the above embodiments for the effective implementation of a method and system for providing direct data placement support. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in conventional computer storage. The programming of the present invention may be implemented by one skilled in the art of network programming.

1. A method for reducing the overhead associated with the direct placement of packet data incoming to a network adapter over a network connection; said method comprising:
a. receiving a header portion of at least one packet at said network adapter;
b. extracting and processing, via logic implemented in hardware, upper layer protocol (ULP) parameter values from said header portion of said at least one packet;
c. storing in software data structure, said ULP parameters values extracted from header portion of at least one packet; and
d. directly placing packet data received in a payload portion of said at least one packet; said placement based on said stored ULP parameters values.

2. A method for reducing the overhead associated with the direct placement of packet data, as per claim 1, wherein said ULP is either of: Internet Small Computer System Interface (iSCSI) or the iWARP protocol suite; said iWARP protocol suite comprising Remote Direct Memory Access Protocol (RDMAP), Direct Data Placement Protocol (DDP), and Marker PDU Aligned Framing for TCP (MPA).

3. A method for reducing the overhead associated with the direct placement of packet data, as per claim 1, wherein said packet data is placed in a memory location specified by at least one of said stored ULP parameter values.

4. A method for reducing the overhead associated with the direct placement of packet data, as per claim 1, wherein said processing step comprises scheduling interrupts on boundaries of said at least one packet.

5. A method for reducing the overhead associated with the direct placement of packet data, as per claim 2, wherein said packet data is directly placed if said stored ULP parameter values satisfy conditions necessary for direct data placement.

6. A method for reducing the overhead associated with the direct placement of packet data, as per claim 2, wherein said logic implemented in hardware performs functions comprising: verifying cyclic redundancy check (CRC) for RDMA messages, marker removal for RDMA messages, and interrupt-scheduling on RDMA message boundaries, if said ULP is the iWARP protocol suite; and interrupt-scheduling on iSCSI Protocol Data Unit (PDU) boundaries, if said ULP is iSCSI.

7. A method for reducing the overhead associated with the direct placement of packet data, as per claim 5, wherein said conditions are comprised of: determining an RDMA message is in sequence, determining that an RDMA message is properly aligned, checking that inbound RDMA write is enabled for an incoming RDMA write message, and checking that inbound RDMA read is enabled for an incoming RDMA read response message; if said ULP is the iWARP protocol suite; else if said ULP is iSCSI, said conditions are comprised of: determining that iSCSI PDUs are received in order, determining correctness of iSCSI PDU header and data digests, and determining that TCP segments in said at least one packet are received in order.

8. A method for reducing the overhead associated with the direct placement of packet data, as per claim 6, wherein said logic implemented in hardware performs functions further comprising: segmenting said payload portion of at least one packet, generating checksums for said at least one packet, inserting markers in said payload portion of at least one packet, performing header and data digests if said ULP is iSCSI, and generating CRCs if said ULP is the iWARP protocol suite.

9. A system for reducing the overhead associated with the direct placement of packet data incoming to a network adapter over a network connection; said system comprising:
a. hardware receiving a header portion of at least one packet incoming to said network adapter; said hardware extracting and processing upper layer protocol (ULP) parameter values from said header portion of at least one packet;
b. software storing said ULP parameters values extracted from said header portion of at least one packet; and
c. direct data placement of packet data received in a payload portion of said at least one packet; said placement based on said stored ULP parameters values.

10. A system for reducing the overhead associated with the direct placement of packet, as per claim 9, wherein said ULP is either of: the iWARP protocol suite or Internet Small Computer System Interface (iSCSI).

11. A system for reducing the overhead associated with the direct placement of packet data, as per claim 9, wherein said packet data is placed in a memory location specified by at least one of said stored ULP parameter values.

12. A system for reducing the overhead associated with the direct placement of packet data, as per claim 9, wherein said processing step comprises scheduling interrupts on boundaries of said at least one packet.

13. An article of manufacture comprising a computer usable medium having computer readable program code embodied therein which implements a reduction of the overhead associated with the direct placement of packet data incoming to a network adapter over a network connection; said medium comprising of modules for:
a. receiving a header portion of at least one packet at said network adapter;
b. extracting and processing, via logic implemented in hardware, upper layer protocol (ULP) parameter values from said header portion of said at least one packet;
c. storing in memory accessible by software, said ULP parameters values extracted from header portion of said at least one packet; and
d. directly placing packet data received in a payload portion of said at least one packet; said placement based on said stored ULP parameter values.

14. An article of manufacture comprising a computer usable medium, as per claim 13, wherein said ULP is either of: the iWARP protocol suite or Internet Small Computer System Interface (iSCSI).

15. An article of manufacture comprising a computer usable medium, as per claim 13, wherein said packet data is placed in a memory location specified by at least one of said stored ULP parameter values.

16. An article of manufacture comprising a computer usable medium, as per claim 13, wherein said processing step comprises scheduling interrupts on boundaries of at least one packet.

17. An article of manufacture comprising a computer usable medium, as per claim 14, wherein said packet data is directly placed if said stored ULP parameter values satisfy conditions necessary for direct data placement.

18. An article of manufacture comprising a computer usable medium, as per claim 14, wherein said logic implemented in hardware performs functions comprising: verifying cyclic redundancy check (CRC) for RDMA messages, marker removal for RDMA messages, and interrupt-scheduling on RDMA message boundaries, if said ULP is the iWARP protocol suite; and interrupt-scheduling on iSCSI Protocol Data Unit (PDU) boundaries, if said ULP is iSCSI.

19. An article of manufacture comprising a computer usable medium, as per claim 17, wherein said conditions are comprised of: determining an RDMA message is in sequence, determining that an RDMA message is properly aligned, checking that inbound RDMA write is enabled for an incoming RDMA write message, and checking that inbound RDMA read is enabled for an incoming RDMA read response message; if said ULP is the iWARP protocol suite; else if said ULP is iSCSI, said conditions are comprised of: determining that iSCSI PDUs are received in order, determining correctness of iSCSI PDU header and data digests, and determining that TCP segments in said at least one packet are received in order.

20. An article of manufacture comprising a computer usable medium, as per claim 18, wherein said logic implemented in hardware performs functions further comprising: segmenting said payload portion of at least one packet, generating checksums for said header portion of said at least one packet, performing header and data digests if said ULP is iSCSI, and inserting markers in said payload portion of at least one packet and generating CRCs if said ULP is the iWARP protocol suite.
